(19) United States
(12) Patent Application Publication
(10) Pub. No.: US 2017/0137683 A1
(43) Pub. Date: May 18, 2017

(54) Liquid Aloe and Polyacrylamide Cold Pack

(71) Applicants: William E. Branum, Laguna Niguel, CA (US); Richard M. Green, Hemet, CA (US)

(72) Inventors: William E. Branum, Laguna Niguel, CA (US); Richard M. Green, Hemet, CA (US)

(21) Appl. No.: 14/943,298

(22) Filed: Nov. 17, 2015

(51) Int. Cl. C09K 5/06

(52) U.S. Cl. CPC C09K 5/066

(57) ABSTRACT

Improvements in the cold pack with a sustained temperature of between 17 and 40 degrees Fahrenheit for over 2 hours and as long as 9 hours. The aloe and polyacrylamide cold pack can be configured not to continually condense or drip water for over 2 hours when using the ingredients of Ammonium C12-C15, Pareth Sulfate Ammonium C12-C15, Pareth Sulfate, Sodium Chloride, Poloxamer 124 DMDM Hydantoin Pent sodium Pentatate, Sodium Bisulfite. The main ingredients in regulating the ice pack temperature, longevity and hardness is the aloe, H2O and polyacrylamide ratio.

### CROSS REFERENCE TO RELATED APPLICATION

This application is a continuation-in-part of applicant's co-pending application Ser. No. 62/127,358 filed Mar. 3, 2015 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in a cold pack. More particularly, the present cold pack is Aloe in a liquid form, H2o, polyacrylamide mix that can maintain a certain temperature for an extended period of time. By varying the ingredients ratio and adding others materials, we can increase or decrease the temperature it holds. In some cases we can also extend the length of time it holds the desired temperature.

Description of Related Art including information disclosed under 37 CFR 1.97 and 1.98:

For athletes and people who require cold therapy to relieve pain or promote healing, a cold pack that can be placed directly onto the surface of the skin and provides relief. Cold packs have taken a variety of types. Early types of cold packs we simply ice cubes placed in a bag or rag. More modern cold packs utilize chemicals to allow the cold pack to be more flexible and extend the period of time the pack remains useful.

A number of patents and or publications have been made to address these issues. Exemplary examples of patents and or publication that try to address this/these problem(s) are identified and discussed below.

U.S. Pat. No. 5,478,988 issued on Dec. 26, 1995 to Thomas E. Hughes et al, discloses a Thermal Exchange Composition and Articles for use thereof. This cold pack uses a thermal exchange composition made from clay, glycol and/or water for retaining and slowly releasing hot and cold temperature. The formulation provides short term stability, not long term stability of 4 or more hours with changes in the ratios and additives and as always condensation forms when in use.

U.S. Pat. Nos. 5,723,063 and 6,051,159 issued on Mar. 3, 1998 and Apr. 18, 2000, respectively, both to Jie Hao disclose Soft Ice. These patents are a composition of matter comprising 70% to 80% water, 5-10% salt, 12-15% glycerine and 3-5% polyacrylamide in an enclosed flexible bag. While the soft ice provides a flexible cooling therapy device, the chemical composition provides limited cold thermal longevity.

U.S. Pat. Number 6,610,084 issued on Aug. 26, 2003 to Ernesto A. Torres discloses a Shapeable Pack for Cold Therapy. The pack comprises a plurality of encapsulated units, wherein a mixture of a NaCl based salt dissolved in water that is encapsulated in polyacrylamide.

What is needed is a long lasting (over 3 hours) ice pack made of liquid aloe (used for temperature stability), polyacrylamide (for conforming fit), and H2O. The aloe and polyacrylamide water cold pack in this document provides the solution.

### BRIEF SUMMARY OF THE INVENTION

It is an object of the liquid aloe and polyacrylamide cold pack to be lightweight. It covers a large area while being 40% lighter than other products of similar size. Because the aloe and polyacrylamide cold pack is light weight, a larger surface area of the body can be covered by the product without adding too much pressure to the area being treated. The formula are used it has industrial applications in transporting perishable items.

It is an object of the liquid aloe and polyacrylamide cold pack to provide a cold pack that does not cause freezer burn in direct contact with the exterior packaging. It does not burn the skin even in direct contact with the exterior packaging when using the therapeutic formula. Physicians recommend using cold therapy for 20 min at a sustained temperature of 40 degrees Fahrenheit. Currently this is done by a machine. Otherwise you have your pick of products that are heavy, non-conforming and do not meet the temperature recommendations. The aloe and polyacrylamide cold pack is comfortable within 5 min of use. The wearer will not think that he is wearing a cold pack because the body readily tolerates the 40 degree temperature stability the product provides. The cold pack maintains a sustained temperature of between 17 and 40 degrees Fahrenheit for over 2 hours thereby making it very comfortable compared to freezing temperatures in some products that are stiff, heavy and numbingly painful. The product is 17 to 40 degrees Fahrenheit of cold therapy minutes out of the freezer. Currently this is done by a machine. Otherwise you have your pick of products that are heavy, non-conforming and do not meet the temperature recommendations.

It is an object of the liquid aloe and polyacrylamide cold pack to provide a cold pack that reduces condensation. This eliminates the need for heavy absorbent materials when applying the ice pack to the body. It can be used in sensitive areas of the body where condensed water formation would be an issue to wound care. It can be used and has been used in back pain management in bed without the residue of water, which is an undesirable factor when you fall asleep while using it. It allows the user to reduce moisture volume in the area of use.

It is another object of the liquid aloe and polyacrylamide cold pack to be conforming to the body where it can be used in medical applications, surgery, post-op, genital and anal surgery where conforming materials are preferred. Eye surgery, where cold packs in a lightweight and conforming product are mistaken as ice cubes in a towel are replaced by a product in a latex cover that conforms to the area. Since the material is very conforming knee and elbow, foot, arm, hand and any other parts of the body that cold therapy can be covered.

It is another object of the liquid aloe and polyacrylamide cold pack to be used for workers who work in high heat areas where a lightweight cooled vest could increase the safety and comfort of the worker. This can also be used to cool football players and other professionals, maintaining a cool but not cold climate in various forms like boots, gloves, modified towels etc. The cold pack controls overheating during exercise by placing the product into clothing that can be worn. Also various occupations that are in close proximity to high heat.

It is still another object of the liquid aloe and polyacrylamide cold pack to be placed in products, the list is endless. For example, cold drink cups that don't continuously condense and drip water on you while keeping the drink cold for hours.

It is still another object of the liquid aloe and polyacrylamide pack to be used in the heat therapeutic form where it can be heated in a microwave.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a chart of ice packs for commercial applications with the cold pack frozen at the start of test. Some ratios of this embodiment may or may not suppress condensation.

FIG. 2 shows temperature stability using different ratios.

FIG. 3 shows a front view of a preferred embodiment of a bag with the liquid aloe and polyacrylamide.

FIG. 4 shows a side view of a preferred embodiment of a bag with the liquid aloe and polyacrylamide.

### DETAILED DESCRIPTION OF THE INVENTION

The liquid aloe and polyacrylamide cold pack uses a combination of 28 g+/−7 g polyacrlamide, H2O 236 ml+/−30 ml and 28 ml of 100% pure +/−10% liquid aloe, or extract of aloe, (Ammonium C12-C15 1-2%+1%−2% and or Pareth Sulfate 1-2%+/−1%, Ammonium C12-C15 1%+1%−1%, Sodium Chloride 2%+1/−2%, Poloxamer 124 DMDM 1%+0−1%, Hydantoin Pent sodium Pentatate 1%+/−1%, Sodium Bisulfite 1%+/−1%, with (not necessary for appearance only Liquitint dyes Methylchloroisothiazolinone Methylisothiazolinone less than 1%+/−1%).

The formula can maintain a temperature of 17 to 40 degrees Fahrenheit for over two hours that is conforming to the body when packaged properly. Does not condense appreciably until over two hours have passed and then producing only slight condensation that was not even enough to saturate a two ply tissue. The polyacrylamide cold pack is comfortable within 5 min of use after removal from a freezer. The polyacrylamide cold pack can be very lightweight with variations to the formula.

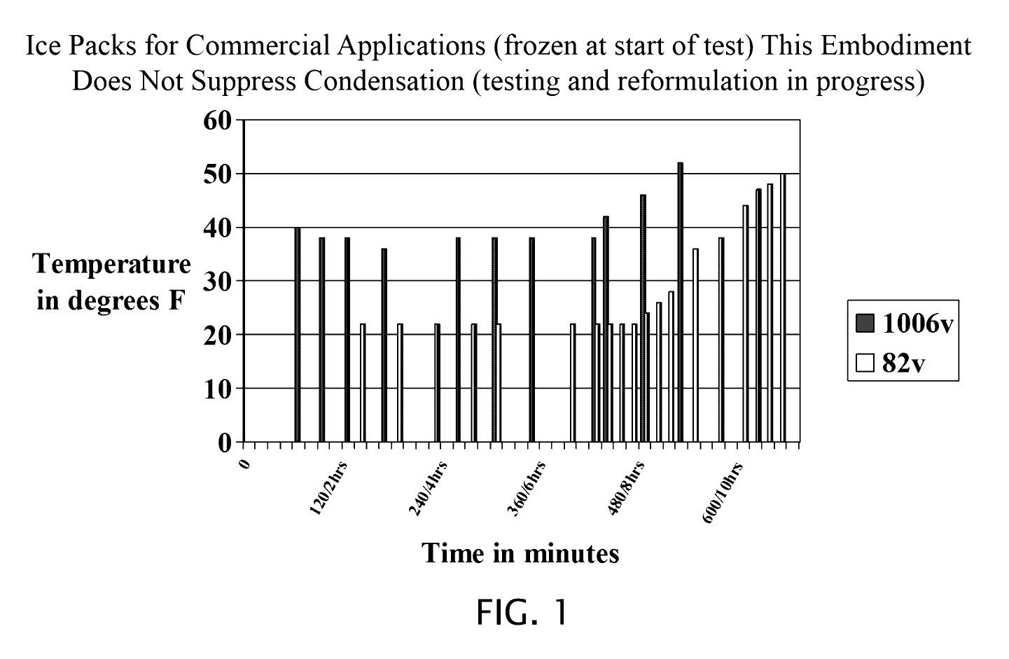

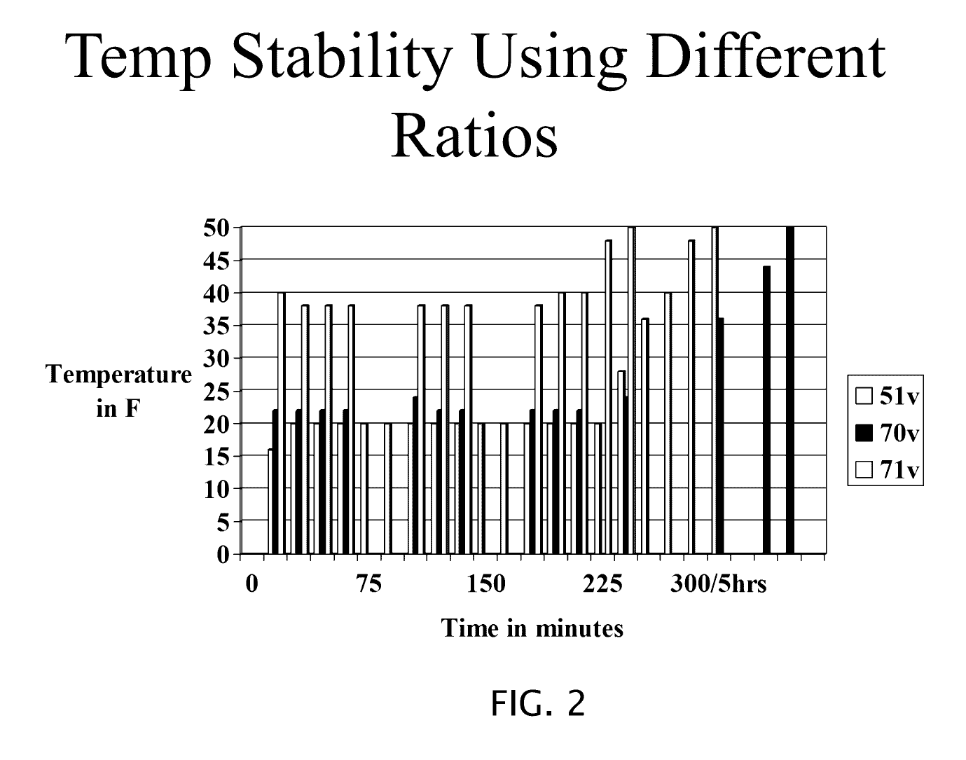

FIG. 1 shows a chart of ice packs for commercial applications with the cold pack frozen at the start of test. Some ratios of this embodiment may or may not suppress condensation and FIG. 2 shows temperature stability using different ratios. The testing is done in open air and having an ambient 78 degree Fahrenheit temperature. In these charts, one formula is about 30 degrees Fahrenheit and a second formula is about 40 degrees Fahrenheit. The second formula is the recommended temperature for use as a medical cold therapy produce. It is also noted that various formulations produce some temperature of less than 17 degrees and are designed for longevity and not condensation control. Thus, not requiring the additives Ammonium C12-C15, Pereth Sulfate Ammonium C12-C15, Pareth Sulfate, Sodium Chloride, Poloxamer 124 DMDM Hydantion Pent sodium Pentatate, Sodium Bisulfate.

The general formula will hold the initial temperature consistently during that time. After 2-4 hours the product will start to breakdown and return to room temperature. It will then begin to sweat or condense while other products begin to condense almost as soon as you remove them from the freezer. But that condensation is very light and will not create a high volume of moisture even in this state.

General Process Information:

Cold packs are primarily made of polyacrlamide, water and aloe. It can be made by combining the 28 g+/−7 g polyacrlamide, H2O 236 ml+/−30 ml and 28 ml of 100% pure+/−10% liquid aloe, or extract of aloe, (Ammonium C12-C15 1-2%+1%−2% and or Pareth Sulfate 1-2%+/−1%, Ammonium C12-C15 1%+1%−1%, Sodium Chloride 2%+1/−2%, Poloxamer 124 DMDM 1%+0−1%, Hydantoin Pent sodium Pentatate 1%+/−1%, Sodium Bisulfite 1%+/−1%, with (not necessary for appearance only Liquitint dyes Methylchloroisothiazolinone Methylisothiazolinone less than 1%+/−1%). Mix well with minimal agitation and without air in the bag.

First Process:

1a: Polyacrlamide with H2O at room temperature (65-78 degrees F.)

1b: Wait for about 75%+0/−20% of the water to be absorbed into the polyacrlamide. Approximate time for absorption is 45 seconds+30 seconds−0.

Combine:

2a: Contents of bag with formula.

2b: Remove air and foam.

2c: Mix well with minimal agitation.

2d: Form the 15 mm×14 mm×0.2 mm plastic bag into a flat rectangle and freeze the mixture at −2 degrees F. Creates a bag 15 mm×14 mm×approximately 2-4 mm thick. Produces a stable temperature between 32-40 degrees F. for 2-4 hours at room temperature (68-78 degrees F.).

The therapeutic formula will hold the initial temperature of 40 degrees+/−7 degrees F. consistently during that time. After 2-4 hours the product will start to breakdown and return to room temperature.

Formulations or variants in the amount of Formula used in the mixture vary the stable temperature and longevity of the product. Tests run at room temperature show that adding 28 ml of the formula drops the stable temperature from 40 degrees F. to 29 degrees F. This obviously can be modified to suit the circumstances.

The preferred ratio of water to aloe is 4 parts H2O to 3 parts formula. This creates a hard pack of iced material that is not suitable for therapy but optimized for industrial applications. Decreasing or maintaining the H2O relative to the aloe content while other factors remain within their percentages, increases the longevity and decreases the stable temperature from 32-40 degrees to as low as 17 degrees F.+/−5 degrees and lasts for as much as 5-10 hours (at a room temperature of between 68-78 degrees F.) before the temperature reaches 50 degrees F.

Within an insulated compartment the cold pack with increase liquid aloe content and a mix ratio of 4 H2O to 3 of liquid aloe has an initial temperature of 17-25 degrees F. and after 25+ hours after freezing is still at 32 degrees F. This change in ratio drives the stable temperature and longevity of use and is necessary for applications of food/perishable storage as opposed to the initial formula that is more limited in length of useable time and the temperature it maintains (usually 32-40 degrees as opposed to 17-27 degrees in cold storage applications). Note: All factors and time to failure are based upon a max useable temperature of 50 degrees. Factors are approximate and can vary with freezing temperatures, ambient temps and insulating factors of various materials used in the tests.

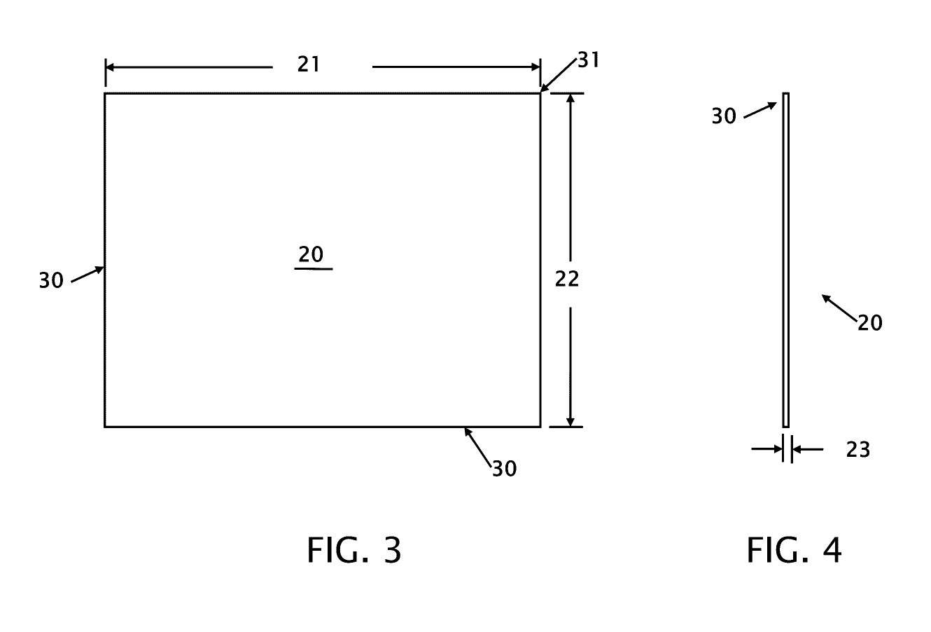

FIG. 3 shows a front view of a preferred embodiment of a bag 20 with the liquid aloe and polyacrylamide and FIG. 4 shows a side view of a preferred embodiment of a bag 20 with the liquid aloe and polyacrylamide. In one preferred embodiment the bag has flat dimensions of 21 and 22 of approximately 14 mm×15 mm. The thickness 23 is approximately 0.1 mm. The edges 30 of the bag 20 are sealed and the bag 20 can have an openable side 31 to mix and burp the bag 20. After the ingredients are mixed and stabilized the bag can be sealed to prevent leaking, contamination or tampering.

A re-closable bag is filled with 120 ml of water, then 15 ml of polyacrylamide is added. This mixture stands till most of the water is absorbed (approximately 75% and there is still some clear liquid left then add the aloe mixed with the other ingredients of Ammonium C12-C15, Pareth Sulfate Ammonium C12-C15, Pareth Sulfate, Sodium Chloride, Poloxamer 124 DMDM Hydantoin Pent sodium Pentatate, Sodium Bisulfite, 2 tablespoons. The combination is mixed by sealing the materials inside the re-closable bag and squeezing or kneading the material till the combination is mixed and the contents are all the same color of blue. The re-closable bag is opened and air and foam is removed from the re-closable bag. The re-closable bag is sealed after removing all air and foam. Once an airtight seal is in place, the re-closable bag is formed into a flat rectangle and freezing the mixture at −2 degree Fahrenheit creates a bag 8″×7″×approximately 0.250-0.375 thick. Produces a temperature between 17-40 degree Fahrenheit for 2-4 hours at room temperature 72 degrees Fahrenheit as shown in figure.

Secondary process allows for a large lightweight variation:

By adding water 120 ml and another 15 ml of thepolyacrylamide you can increase the surface area that the material will cover and it will be very lightweight the material will expand the sandwich bag to its maximum size and thickness as opposed to the initial product that is the length and the width of the bag and is approximately 0.250-0.375 in thickness. The variation increases the thickness to around 2.5 to 3.0 inches at its maximum thickness. This pack will only last 1-2 hours at temperature. Modifications to the formula may lengthen the meantime to failure of the bag for rupturing as the bag is conformed, as seen in the figures where the graph shows that we can increase the stability by hours.

Formulations or variants in the amount of aloe and crystals used in the mixture appear to vary the stable temperature. Tests run at room temperature show that adding one tablespoon of aloe mix drops the stable temperature from 40 degrees Fahrenheit to 29 degrees Fahrenheit. This obviously can be modified to suit the circumstances. Although more tests to observe the stability of the formula at the different temperatures is needed, tests already completed show the break down in both samples occur somewhere around the same 3-4 hour time frame as shown in the figures.

Thus, specific embodiments of an aloe, polyacrylamide cold pack has been disclosed. It should be apparent, however, to those skilled in the art that many more modifications besides those described are possible without departing from the inventive concepts herein. The inventive subject matter, therefore, is not to be restricted except in the spirit of the appended claims.

1. A liquid aloe and polyacrylamide cold pack comprising:
a combination of 28 g+/−7 g polyacrylamide;
236 ml+/−30 ml H2O;
28 ml+/−10% of 100% pure liquid aloe, or extract of aloe;
0% to 3% Ammonium C12-C15 or Pareth Sulfate;
0%-2% Ammonium C12-C15;
0%-3% Sodium Chloride;
0%-1% Poloxamer;
0%-2% 124 DMDM Hydantoin Pent sodium Pentatate;
0%-2% Sodium Bisulfite, and
0%-2% liquitint dyes Methylchloroisothiazolinone Methylisothiazolinone.

2. The liquid aloe and polyacrylamide cold pack according to claim 1 that maintains a sustained temperature of between 17 and 40 degrees Fahrenheit.

3. The liquid aloe and polyacrylamide cold pack according to claim 1 wherein said cold pack is configured to be between 0.125 and 0.500 inches thick.

4. The liquid aloe and polyacrylamide cold pack according to claim 1 wherein said cold pack is heatable in a microwave oven or in boiling water.

5. The liquid aloe and polyacrylamide cold pack according to claim 1 wherein said cold pack is configured in a size of 8.000×7.000 inches and 0.250 to 0.375 inches thick and increases thickness from 2.000 to 3.000 inches thick during freezing.

6. The liquid aloe and polyacrylamide cold pack according to claim 1 wherein said cold pack maintains a temperature of 17 to 40 degrees Fahrenheit for over two hours.

7. The liquid aloe and polyacrylamide cold pack according to claim 6 wherein said cold pack for over two hours does not continually condense and drip water.

8. The liquid aloe and polyacrylamide cold pack according to claim 1 wherein said cold pack is pliable and conformable.

9. The liquid aloe and polyacrylamide cold pack according to claim 1 wherein said combination further includes a closable or reclosable bag.

10. The liquid aloe and polyacrylamide cold pack according to claim 1 further includes a boot, glove or towel.

11. A method of making a liquid aloe and polyacrylamide cold pack comprising:
filling a closable bag with 120 ml of water;
adding 15 ml of polyacrylamide to said closable bag;
allowing said polyacrylamide to absorb at least 75% of said water;
adding two tablespoons of a mixture of aloe, Ammonium C12-C15, Pareth Sulfate Ammonium C12-C15, Pareth Sulfate, Sodium Chloride, Poloxamer 124 DMDM Hydantoin Pent sodium Pentatate, Sodium Bisulfite;
mixing combined ingredients in said closable bag until said mixed contents are essentially all the same color of blue;
opening said closable bag and removing air and foam from within said closable bag, and closing said closable bag.

12. The method of making a liquid aloe and polyacrylamide cold pack according to claim 11 further includes sealing said closable bag.

13. The method of making a liquid aloe and polyacrylamide cold pack according to claim 11 wherein said mixing is with squeezing, kneading.

14. The method of making a liquid aloe and polyacrylamide cold pack according to claim 11 further includes forming said closable bag into a flat rectangle.

15. The method of making a liquid aloe and polyacrylamide cold pack according to claim 14 wherein said flat rectangle is configured to be between 0.125 and 0.375 inches thick.

16. The method of making a liquid aloe and polyacrylamide cold pack according to claim 14 wherein said cold pack is configured in a size of 8.000×7.000 inches and 0.250 to 0.375 inches thick.

17. The method of making a liquid aloe and polyacrylamide cold pack according to claim 11 further includes refrigerating said mixed combined ingredients in said closable bag.

18. The method of making a liquid aloe and polyacrylamide cold pack according to claim 11 wherein said mixed combined ingredients in said closable bag produces a stable temperature between 32-40 degrees F. for 2-4 hours at room temperature of between 68 and 78 degrees F.

19. The method of making a liquid aloe and polyacrylamide cold pack according to claim 11 wherein said absorption is between 45 seconds and 75 seconds.

20. The method of making a liquid aloe and polyacrylamide cold pack according to claim 11 wherein mixed combined ingredients in said closable bag is pliable and conformable.
